(19) United States
(12) Patent Application Publication
(10) Pub. No.: US 2018/0101809 A1
(43) Pub. Date: Apr. 12, 2018

(54) Real-time update of a mobile workforce schedule

(71) Applicant: International Business Machines Corporation, Anmonk, NY (US)

(72) Inventors: Jonathan Bnayahu, Haifa (IL); Michael Katz, Nahariya (IL); Vladimir Lipets, Haifa (IL); Michael Masin, Haifa (IL); Dany Moshkovich, Yokneam llit (IL); Daniel C. Selman, Plevin (FR); Segev E. Wasserkrug, Haifa (IL)

(21) Appl. No.: 15/286,577

(22) Filed: Oct. 6, 2016

(51) Int. Cl. G06Q 10/06; G06Q 10/10

(52) U.S. Cl. CPC G06Q 10/063116; G06Q 10/10

(57) ABSTRACT

A method, apparatus and product for real-time update of a Mobile Workforce Scheduling Problem (MWSP), which comprises: agents and tasks to be performed by the agents, wherein a schedule which solves the mobile workforce scheduling problem exists and is being implemented by the agents. The method comprising: monitoring real time information update events provided to a Business Rule Management System (BRMS), activating, by the BRMS, business rules for schedule change detection; in response to a determination that re-planning is desired, automatically determining, using business rules, a portion of the MWSP to be re-planned; providing the portion of the MWSP to a MWSP solver; receiving from the MWSP solver, a new schedule for the portion of the MWSP; and updating the schedule based on the new schedule, whereby a first portion of the schedule is updated and a second portion of the schedule remains unchanged.

### TECHNICAL FIELD

The present disclosure relates to scheduling problems in general, and to mobile workforce scheduling problems, in particular.

### BACKGROUND

The scheduling and routing of a mobile workforce is a challenge faced by many companies in many different domains (telco, insurance, banking, IT, E&U, etc.).

Mobile workforce scheduling is a computationally challenging task. Mobile workforce scheduling is a task of assigning mobile agents to perform tasks, often at remote locations, during designated time frames. For example, in case of a telecommunications company having a fleet of technicians, and a set of service calls to be handled, the scheduling problem may include the selection of which service calls, and at what order, each technician would perform.

### BRIEF SUMMARY

One exemplary embodiment of the disclosed subject matter is a method for real-time update of a Mobile Workforce Scheduling Problem (MWSP), wherein the MWSP comprises: a set of agents and a set of tasks to be performed by the set of agents, wherein a schedule which solves the mobile workforce scheduling problem exists and is being implemented by the set of agents, the method comprising: monitoring real time information update events provided to a Business Rule Management System (BRMS), the real time information update events relate to real-time implementation of the schedule; activating, by the BRMS, one or more business rules for schedule change detection, wherein the one or more business rules for schedule change detection are configured to detect a requirement to change the schedule based on the real-time implementation of the schedule; in response to a detection of a requirement to change the schedule, triggering a re-planning event; in response to the re-planning event, automatically determining a portion of the MWSP to be re-planned, wherein said automatically determining the portion of the MWSP to be re-planned is based on one or more business rules; providing the portion of the MWSP to a MWSP solver; receiving from the MWSP solver, a new schedule for the portion of the MWSP; and updating the schedule based on the new schedule, whereby a first portion of the schedule is updated and a second portion of the schedule remains unchanged.

Another exemplary embodiment of the disclosed subject matter is a computerized apparatus for updating a Mobile Workforce Scheduling Problem (MWSP) in real-time, wherein the MWSP comprises: a set of agents and a set of tasks to be performed by the set of agents, wherein a schedule which solves the mobile workforce scheduling problem exists and is being implemented by the set of agents, the apparatus comprising a processor configured to perform the steps of: monitoring real time information update events provided to a Business Rule Management System (BRMS), the real time information update events relate to real-time implementation of the schedule; activating, by the BRMS, one or more business rules for schedule change detection, wherein the one or more business rules for schedule change detection are configured to detect a requirement to change the schedule based on the real-time implementation of the schedule; in response to a detection of a requirement to change the schedule, triggering a re-planning event; in response to the re-planning event, automatically determining a portion of the MWSP to be re-planned, wherein said automatically determining the portion of the MWSP to be re-planned is based on one or more business rules; providing the portion of the MWSP to a MWSP solver; receiving from the MWSP solver, a new schedule for the portion of the MWSP; and updating the schedule based on the new schedule, whereby a first portion of the schedule is updated and a second portion of the schedule remains unchanged.

Yet another exemplary embodiment of the disclosed subject matter is a computer program product or real-time update of a Mobile Workforce Scheduling Problem (MWSP), wherein the MWSP comprises: a set of agents and a set of tasks to be performed by the set of agents, wherein a schedule which solves the mobile workforce scheduling problem exists and is being implemented by the set of agents, wherein said computer program product comprising a computer readable storage medium retaining program instructions, which program instructions when read by a processor, cause the processor to perform a method comprising: monitoring real time information update events provided to a Business Rule Management System (BRMS), the real time information update events relate to real-time implementation of the schedule; activating, by the BRMS, one or more business rules for schedule change detection, wherein the one or more business rules for schedule change detection are configured to detect a requirement to change the schedule based on the real-time implementation of the schedule; in response to a detection of a requirement to change the schedule, triggering a re-planning event; in response to the re-planning event, automatically determining a portion of the MWSP to be re-planned, wherein said automatically determining the portion of the MWSP to be re-planned is based on one or more business rules; providing the portion of the MWSP to a MWSP solver; receiving from the MWSP solver, a new schedule for the portion of the MWSP; and updating the schedule based on the new schedule, whereby a first portion of the schedule is updated and a second portion of the schedule remains unchanged.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic illustration of a computerized environment in which the disclosed subject matter is used, in accordance with some exemplary embodiments of the subject matter; and

FIG. 2 shows a block diagram of a system in accordance with some exemplary embodiments of the disclosed subject matter.

### DETAILED DESCRIPTION

One technical problem dealt with by the disclosed subject matter is to provide for a flexible framework that can monitor performance of a schedule that solves a Mobile Workforce Scheduling Problem (MWSP). In some cases, based on monitored events, re-planning requirement may be identified and acted upon.

One technical solution is to provide for a Business Rule Management System (BRMS) that implements business rules for schedule change detection based on real time information update events. In response to a triggered re-planning event by the BRMS, a portion of the MWSP may be provided to a MWSP solver for re-planning. The new schedule determined by the MWSP solver may be integrated into the existing schedule.

In some exemplary embodiments, a BRMS, such as IBM Operational Decision Management™, may be configured to define, deploy, execute and maintain variety of business rules that are used by operational systems associated with an organization. The business rules may include policies, requirements, conditional statements, or the like that may be used to determine actions taken place in the operational systems. In some exemplary embodiments, the business rules may be provided by a non-programmer user (referred to as a business user), who may be domain-expert of the specific business related issue that is addressed by the business logic.

A set of business rules may be provided to a BRMS to monitor actual execution of a schedule of a solution to a MWSP. Additional business rules may be provided to decide when re-planning (i.e., rescheduling) needs to be carried out based on a real-time events monitored by the BRMS. In some exemplary embodiments, the business rules may be configured to trigger a re-planning event upon a determination that a re-planning is required. It will be noted that a business user may provide for flexible rules that can implement business related issues. As an example, tasks that are associated with VIP clients may be treated differently than non-VIP clients, where the identification of who is a VIP client and the different handling procedure may be set by the business user, in an organization-specific set of rules. As another example, a monetary cost of a schedule delay may be computed by the business rules, and based on such cost, the re-planning determination may be made.

One technical effect of the disclosed subject matter may be increased efficiency and improved performance by the overall system.

In some exemplary embodiments, the MWSP may be an NP-hard problem, which cannot be solved in a polynomial time. In real-life usages of MWSP solvers, extensive resources, such as computation time and memory usage, may be required. Performing a re-planning may thus may not be a task that is desired to be invoked redundantly or without good cause. The flexibility achieved by using business rules may address the challenge of having in each organization different “best practice” rules to determine when re-planning is desired.

In some exemplary embodiments, the disclosed subject matter may achieve a more efficient plan updates resulting in significant cost savings due both to automatically detecting when re-planning needs to take place, and deciding what can be changed.

Additionally or alternatively, organization-specific best practices may be captured, resulting in overall improved performance, that is not scheduler specific.

Additionally or alternatively, business rules provide for flexibility in changing the rules based on changing conditions (e.g. new regulations, new service commitments, creating different rules for different seasons, etc.), thereby providing for a flexible solution to a varying instances of a NP-hard problem.

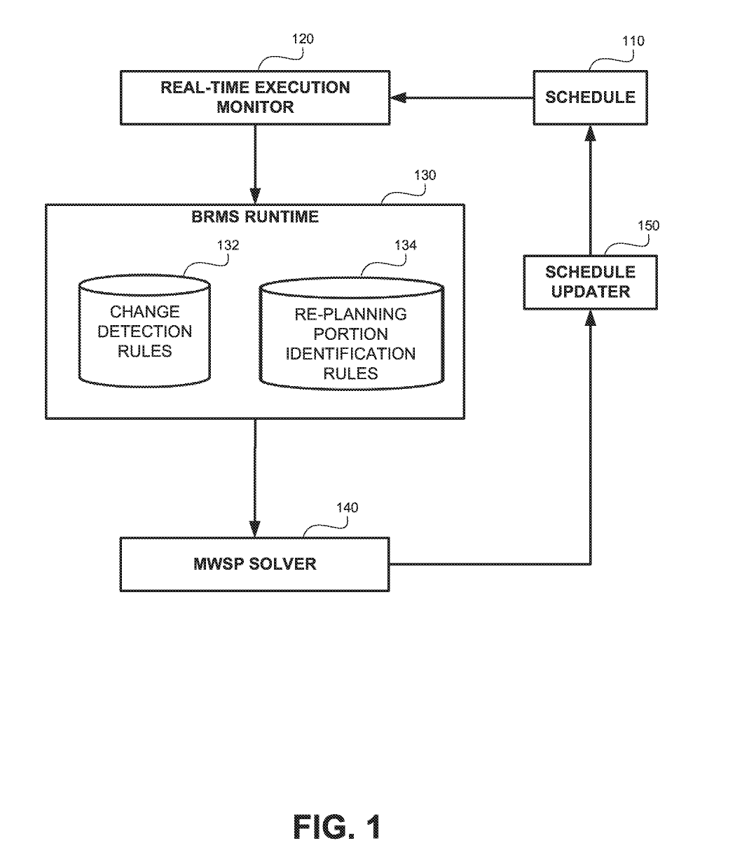

Referring now to FIG. 1 showing a computerized environment in which the disclosed subject matter is used, in accordance with some exemplary embodiments of the subject matter.

An initial schedule (Schedule 110) may be provided. Schedule 110 may be created manually or using an automated system, such as MWSP Solver 140. Schedule 110 may define a schedule for agents to perform tasks. Each agent may be assigned with a time to handle each task. The schedule may take into account the different locations of the tasks, the distances between the locations, the initial location of each agent (e.g., site from which the agent starts her shift), different skills of the different agents (e.g., the agents may be heterogeneous), different skills required to handle each task (e.g., the tasks may be heterogeneous), the time slot to handle each task (e.g., the time slot in which the customer is asked to stay at the task location), or the like.

During execution of Schedule 110, agents may handle tasks, notify about delays, or the like. In some exemplary embodiments, each agent may utilize a mobile device, such as a handheld computer, a PDA, a tablet, or the like, to provide updates about her status. As an example, the agent may input to the mobile device a status update of the task after discovering a different skill is required thereto, after determining a projected handling time, after completing the task, or the like. Additionally or alternatively, the agent may use the mobile device to notify about delays, such as may occur due to traffic, unexpected events en route, or the like. As another example, the mobile device may periodically send location updates, such as indicating current location of the agent using a Global Positioning System (GPS) receiver or other positioning devices.

Real-Time Execution Monitor (RTEM) 120 may be configured to monitor the real-time execution of Schedule 110. RTEM 120 may receive aggregate events from the mobile devices to monitor the execution of Schedule 110. Additionally or alternatively, RTEM 120 may monitor additional elements, such as Internet of Things (IoT) devices that may be connected thereto via the Internet or another computerized system and provide measurements. As an example, once an agent completes a task, an IoT device may become online and transmit a “heart beat” signal indicating that the device is functioning and that the task was completed. As another example, other IoT devices, that are not the subject of the task, may transmit status update indicating the status of the task that is being handled by the agent.

RTEM 120 may transmit events to Business Rules Management System (BRMS) Runtime 130. BRMS Runtime 130 may execute business rules that may be defined by business users, such as domain experts, operation staff, that can implement business-specific rules that may be unique to the specific organization, regulations that apply thereto, the technological domain of the agents or tasks, or the like. As an example, there may be a Service Level Agreement (SLA) requirement or a mandatory Quality of Service (QoS) requirement that may be monitored by BRMS Runtime 130. For example, the organization may receive a fine if an agent does not start handling a task within a predetermined timeframe (e.g., no more than two hours after the customer was told to wait at the task location; no more than 48 hours after a service call was issued; or the like). The parameters related to the fine may be analyzed by rules in BRMS Runtime 130.

BRMS Runtime 130 may comprise Change Detection Rules 132 and Re-Scheduling Portion Identification Rules 134, both of which may be retained in a computer readable data repository.

In some exemplary embodiments, Change Detection Rules 132 may be configured to detect that the execution differs from Schedule 110 in a significant manner, which requires re-planning. As an example, in case actual execution does not meet target QoS levels, re-planning may be required. It will be noted that in some cases, target QoS levels may different for different portions of Schedule 110, for example: a different QoS level may be applied to VIP customers as opposed to regular customers; different QoS levels may be imposed due to different regulation in different counties, states, countries, or other geographic regions.

Once Change Detection Rules 132 are applied and determine that a re-planning s is required, a re-planning event may be issued. In response to the re-planning event a portion of the MWSP to be re-planned may be determined. The portion of the MWSP may comprise a subset of the agents of the MWSP, a subset of the tasks of the MWSP, or the like. Additionally or alternatively, the portion of the MWSP may include information derived from RTEM 120, such as current locations of the agents, statuses of tasks being processed, a time in which an agent is expected to complete currently assigned task, or the like. The portion of the MWSP may be determined by applying Re-planning Portion Identification Rules 134. Re-planning Portion Identification Rules 134 may comprise business rules that are useful to identifying a portion of the scheduling problem to be re-planned. As an example, only agents in the vicinity of the task to which the previously matched agent will not arrive in time, may need to be considered in the re-planning. As another example, some agents or tasks may be determined to not participate in the re-planning due to business related decisions. For example, the agent assigned to handle a task for a VIP customer may not be re-assigned as such re-planning may adversely affect the VIP customer. In some exemplary embodiments, Re-planning Portion Identification Rules 134 may be configured to not affect an agent currently handling a task, so as to avoid directing an agent that is in the midst of handling a task to suspend her work and start handling a different task in a different location. In some exemplary embodiments, Re-planning Portion Identification Rules 134 may allow for re-assignment of tasks to agents after the agent complete their current tasks. In some exemplary embodiments, a single task may be handled by a plurality of agents, and the re-planning may allow for re-directing agents to assist an agent that is currently handling a task. Additionally or alternatively, if several agents are currently handling a single task, the portion of the MWSP may allow for re-assignment of a portion thereof, so as the task will still be handled without interruption but with reduced efficiency while freeing up one or more agents that are able to handle other tasks.

The portion of the MWSP to be re-planned, also referred to the sub-problem, may be fed to a MWSP Solver 140. MWSP Solver 140 may be configured to solve a MWSP. It will be noted that MWSP may be a NP-hard problem whose solution may require non-polynomial time with respect to its input. MWSP Solver 140 may implement optimizations, approximations, abstractions, or the like to provide for a relatively efficient automated solution to the MWSP. In some exemplary embodiments, a Constraint Satisfaction Problem (CSP) or Boolean Satisfiability Problem (SAT) may be created based on the MWSP and an CSP solver or SAT solver, respectively, may be utilized. The solution to the intermediate problem may be translated to a solution to the MWSP. Additionally or alternatively, brute force enumeration of potential solutions may be performed. Heuristics may be applied to guide the search of the solution space for a solution that would satisfy the MWSP, albeit it may not be the optimal solution. In some exemplary embodiments, MWSP Solver 140 may be the solver that was used to create the original schedule (110). Additionally or alternatively, other means may have been used in creating the original schedule (110).

MWSP Solver 140 may provide a solution to the sub-problem. The solution may be provided to a Schedule Updater 150 which may be configured to update Schedule 110 based on the solution to the sub-problem, reassigning some or all of the agents and/or tasks, according to the solution of the sub-problem. In some exemplary embodiments, some of the task assignments of agents in Schedule 110 may be changed in accordance with the solution to the sub-problem. Additionally or alternatively, timing of handling tasks may be modified in comparison to original schedule (110).

In some exemplary embodiments, execution of the updated schedule may be monitored by RTEM 120. In some exemplary embodiments, BRMS Runtime 130 may issue additional re-planning events and additional modifications to the schedule may be determined and implemented.

### An Embodiment

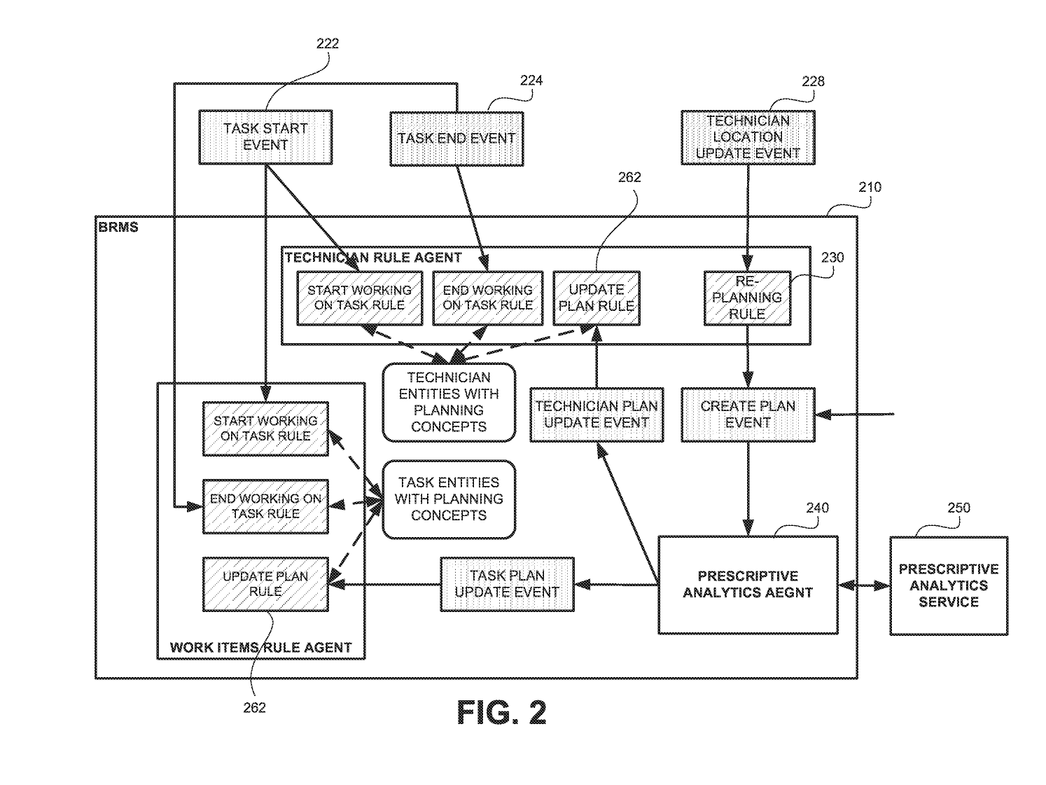

In some exemplary embodiments, a ODM Decision Server Insights (DSI) may be enriched with planning concepts so as to implement an aspect of the disclosed subject matter. In the embodiment below, an agent of the MWSP is referred to as a technician. FIG. 2, which shows a block diagram of a system in accordance with some exemplary embodiments of the disclosed subject matter, provides a schematic illustration of the entities, rules and events of the DSI.

The following is pseudo code useful in DSI indicating that entities:

an technician planning concept is a concept related to
some workItems.
an technician planning concept has

some ‘skills’,
a ‘shift start time’ ( date ) ,
a ‘shift end time’ ( date ) ,
a ‘next work item’ id.

...
a technician has a ‘planning concept’ ( an technician
planning concept) .
a task status can be one of : ‘not started’, ‘in process’,
‘finished’.
a task planning concept is a concept with

some ‘required agent skills’ ,
a ‘earliest start time’ ( date ) ,
a ‘latest end time’ ( date ) ,
a ‘planned start time’ ( date ) ,
a ‘planned end time’ ( date ) ,
a ‘actual start time’ ( date ) ,
a ‘actual end time’ ( date ) ,
a status (a task status) ,
a next work item id.

...
a workItem has a ‘planning concept’ ( a task planning
concept ).

In the embodiment above, the entity technician is enriched with a planning concept. The planning concept for the technician indicates skills of the technician, a start and end time of the technician's shift and the next task (next work item id).

A task entity is enriched with a task planning concept which includes required skills for the task, potential time frame (earliest start time and latest end time), planned time frame according to a schedule (planned start and end time) and execution time frame that is determined during runtime (actual start and end time). In addition, the task planning concept also includes a task status (not started, finished or in process) and a next work item id. In some exemplary embodiments, each task indicates a successive task thereby maintaining a list of tasks. In such an embodiment, if a technician is assigned a list of tasks, she needs only be assigned the first task on the list.

The following DSI planning events may be defined: create plan event which relates to technicians and tasks; a technician plan update that is related to technicians and tasks and has a new next work item id; a task plan update that relates to a task and has a new planned timeframe and next work item id; a task start event relates to both technician and task and comprising actual start time; and a similar event for actual end time: a task end event.

a create plan is a business event related to some
technicians .
a create plan is related to some workItems.
a technician plan update is a business event related to a
technician .
an technician plan update is related to some workItems .
an technician plan update has a ‘new next work item id’ .
a task plan update is a business event related to a
workItem .
a task plan update has a ‘new planned start time’ (date).
a task plan update has a ‘new planned end time’ ( date ).
a task plan update has a ‘new next work item id’.
a task start is a business event related to a workItem .
a task start is related to a technician .
a task start has an ‘actual start time’ ( date ) .
a task end is a business event related to a workItem .
a task end is related to a technician .
a task end has an ‘actual end time’ ( date ) .

Events defined in DSI may include events that are triggered by BRMS 210 (e.g., BRMS Runtime 130 of FIG. 1), or by the environment in which BRMS 210 operates, such as by Real-Time Execution Monitor 120 of FIG. 1. In some exemplary embodiments, the events may be triggered by devices carries by the technician, such as user devices that are used to report a technician's activity, location, or the like.

Event 222, “task start” event, is triggered when a technician starts working on a task. Event 222 is related to both a workItem and a technician and has a property indicating actual start time.

Event 224, “task end” event, is triggered when a technician completes her work on a task. Event 224 is related to workItem and a technician and has a property indicating actual end time.

A create plan event may be an event that is upon BRMS 210 identifying that re-planning is required or desired. The create plan event may include a set of workItems and set of technicians to be part of the re-planning. In some exemplary embodiments, the create plan event may define a portion of the MWSP to be re-planned.

A technician plan update event may be an event that is triggered by BRMS 210 in response to receiving an updated plan. The event may be triggered by Prescriptive Analytics Agent (PAA) 240 after receiving an updated plan from Prescriptive Analytics Service (PAS) 250. The technician plan update event may indicate a technician whose schedule is updated and a set of workItems to be handled by the technician. Additionally or alternatively, the technician plan update event may indicate a next workItem for the technician, and potentially an order of handling the workItems assigned to the technician by the updated plan.

A task plan update event may be an event that is triggered by BRMS 210 in response to receiving an updated plan. The task plan update event may indicate for a workItem a planned start and end time. In some exemplary embodiments, the event may also define a next workItem id.

DSI rules may be executed by BRMS 210. In some exemplary embodiments, software agents that are being executed by BRMS 210 may be responsible to executing the rules when needed.

Plan orchestration may be defined, such as start working on task rule, end working on task rule, Update Plan Rule 262 and Re-Planning Rule 230. Such rules may be executed by a dedicated software agent for handling technicians, denoted as “technician rule agent”. Additionally or alternatively, as some rules may also affect tasks, they may also be executed by a dedicated software agent for handling work items, denoted as “work items rule agent”. In some exemplary embodiments, each software agent may have permission to modify entities of certain types (i.e., technician rule agent may have permissions to modify technicians and not tasks, and work items rule agent may have permissions to modify tasks and not technicians).

“Start working on task” rule may be defined as follows:

when a task start occurs
definitions

set ‘next work Item’ to a workItem in the workItems of

the planning concept of ‘the technician’, where the id of
this workItem is the next work item id of the planning
concept of the workItem of this task start;
then

set the next work item id of the planning concept of

‘the technician’ to the next work item id of the planning
concept of ‘next work Item’;

Such a rule is activated in response to the “task start” event (Event 222). Upon such event being triggered, the rule sets for the technician indicated by Event 222 as starting to handle the workItem indicated in Event 222. In some exemplary embodiments, the rule may also update the actual start time of the task. Additionally or alternatively, additional rules may be responsible to update such data fields, either in addition to or instead of this rule.

“End working on task” rule may be defined as follows:

when a task end occurs
definitions

set ‘next work Item’ to a workItem in the workItems of

the planning concept of ‘the technician’ where the id of
this workItem is the next work item id of the planning
concept of the workItem of this task end ;
then

emit a new set next work item where ...
emit a new technician location update where ...

Such rule is activated in response to the “task end” event (Event 224). Upon such event being triggered, the rule is configured to modify set the next work item ID of the technician to the ID indicated by the workItem as the next task to be handled thereafter. Additionally or alternatively, a new event may be triggered. As an example, a new set next work item event (not shown) may be triggered under some conditions or circumstances. Such an event may trigger additional logic based on the fact that a new task was set, for example, issuing an automated notification to the relevant parties via a text message, e-mail or similar communication method. As another example, a new technical location update event (Event 228) may be emitted, indicating a location of the technician. The location may be determined using a positioning device attached to or carried by the technician, or based on the location of the task which was completed. Additionally or alternatively, after completing the task, active monitoring of the location of the technician may be initiated, thereby reducing power usage of a positioning device used to determine the location of the technician.

Plan orchestration rules to tasks may be defined, such as start working on task rule, end working on task rule, Update Plan Rule 262, and Re-Planning Rule 230. Such rules may be executed by a dedicated software agent for handling technicians, denoted as “technician rule agent”.

Re-Planning Rule 230 may be defined as follows:

when a technician location update occurs
definitions

set ‘next work Item’ to a workItem in the workItems of

the planning concept of ‘the technician’, where the id

of this workItem is the next work item id of the planning
concept of ‘the technician’ ;

set ‘new location’ to the location of this technician

location update ;

set ‘work Item Location’ to the location of ‘next work

Item’ ;

set ‘distance to work item’ to the distance between

‘new location’ and ‘work Item Location’ in meters ;

set ‘required time to work item’ to ‘distance to work

item’ / 1000;

set ‘real time to work item’ to the duration between

the timestamp of this technician location update and the
planned start time of the planning concept of ‘next work
Item’ in minutes ;
If

‘required time to work item’ is more than ‘real time to

work item’
then

define ‘create plan’ as a new create plan;
add the technician of this technician location update to

the technicians of ‘create plan’;
add ‘next work Item’ to the workItems of ‘create plan’

;

emit ‘create plan’;

Re-Planning Rule 230 is activated in response to Event 228. The next task assigned to technician for which Event 228 was triggered is located. The distance between the location of the technician and the location of the next task may be computed. As an example, air distance may be computed. Additionally or alternatively, computations that take into account the travel path which the technician is required to take may be considered in computing the distance. Based on the distance, a computation of the time required for the technician to reach the task location (e.g., travel time) may be computed. In the present example, the speed of the technician is assumed to be 1 km per minute. However, in other embodiments, the time may be computed based on measured speed, historic data, traffic information or the like. In some exemplary embodiments, navigation software may be used to estimate the distance and travel time, based on expected route in view of traffic jams, unexpected events (e.g., accidents), or the like.

The rule may also computed the time left for the technician to reach the task to meet the planned start time (e.g., arrival timeframe). In case the computed travel time is greater than the computed arrival timeframe, re-planning may be considered. In the present example, if such an event occurs, a re-planning event is created and emitted. The re-planning event indicates the portion of the MWSP to include the technician and her task.

It will be noted that the above is a simple example, in which the change detection rules (e.g., 132 of FIG. 1) are naïve and straightforward. Other embodiments may perform additional computations and selections so as to trigger re-planning events only for a delay of certain magnitude, which may be affected by the quality of the customer (e.g., reduced delay for a high quality customer). In some exemplary embodiments, overall delays of the system may be computed and utilized to determine whether re-planning is required. In some exemplary embodiments, monetary cost of delays may be computed and utilized in the determination of whether re-planning is desired.

Re-planning portion identification rules (e.g., 134 of FIG. 1) may include the technician that is being delayed and her work item, as well as additional technicians and work items which may be determined by a re-planning agent (not shown). In some exemplary embodiments, a business user having domain expertise may define the portion identification rules, such as to include also technicians that are located in proximity may be identified and added to the portion of the MWSP that is being re-planned, potentially together with their tasks. In some exemplary embodiments, technicians that handle high quality customers may be skipped to avoid reducing quality of service for such customers, while technicians handling low quality customers may be included in the re-planning even if they have already reached the task location and started handling the task. The business user may define any rules as she sees fit based on the domain and specific requirements of the organization.

In some exemplary embodiments, Prescriptive Analytics Agents (PAA) 240 may be a software agent that is responsible for handling of the re-planning events (with work items and technicians whose plan is compromised) that were generated by the rules of BRMS 210.

In some exemplary embodiments, upon detecting the re-planning event (e.g., “create plan” event), PAA 240 may identify the technicians and tasks to be involved in the re-planning process, i.e., implement re-planning portion identification rules (e.g. 134 of FIG. 1). The determination of the technicians and tasks to be involved in the re-planning may comprise spatiotemporal analytics, business rules which may define what can be changed and in what way, or the like. In some exemplary embodiments, the determination may also comprise multiple invocations of PAS 250 to evaluate multiple alternative plans.

In some exemplary embodiments, PAA 240 may invoke a Spatiotemporal Analytics Agent (STAA) (not shown) which may be responsible for selecting of all of the technicians that can potentially be involved in the updated plan (such as, for example, based on their actual location, predicted traffic conditions, and existing plans). The technicians selected by STAA may be sent to one or more business rule logic that is used to filter the list. The business rule logic may select only those technicians that can be involved in the re-planning process according to the business logic. As an example, the filtering may take into account regulations, preferences, monetary and non-monetary costs, or the like.

In some exemplary embodiments, PAA 240 may further select all potential tasks that can be affected by the re-planning process, such as all tasks that are scheduled to be handled by the filtered list of technicians. The list of tasks may be filtered, such as by applying business rules. As an example, the business rules may classify the tasks (e.g., tasks that can be executed by a different technician, tasks that can be cancelled, task whose timing may be modified) and utilize the classifications for the filtering of the tasks.

PAA 240 may invoke PAS 250 on the sub-problem that comprises the filtered lists of technicians and tasks. PAS 250 may be or employ a solver, such as 140 of FIG. 1, to attempt determining a plan.

In some exemplary embodiments, PAA 240 may compare several different proposed plans. For each plan, a score may be computed. In some exemplary embodiments, PAA 240 may invoke business rules to evaluate the proposed plan and compute the score thereof. The score may take into account the plan itself, its affect on the entire plan, or the like. In some exemplary embodiments, the score may be computed for the plan for the entire MWSP if the proposed plan of the portion of MWSP is adopted.

In some exemplary embodiments, the alternative plans may be provided by different solvers employed by PAS 250. Additionally or alternatively, PPA 240 may create different alternative sub-problems, such as by providing varied degrees of freedom in the filtering processes. The degrees of freedom may be controlled by business rules defined by the business user. Each alternative sub-problem may be sent to PAS 250 to be solved. One or more proposed plans for each sub-problem may be determined by PAS 250.

In some exemplary embodiments, the sub-problems may be solved in a distributed manner by sending each sub-problem to a different computing machine for analysis. Some sub-problems may be computationally hard and may take substantial resources (e.g., CPU and memory) to solve. As such, distributed analysis may provide for an efficient manner to implement re-planning without being adversely affected by computationally hard sub-problems. The re-planning process may continue until a proposed plan having a score above a threshold is determined. Additionally or alternatively, the re-planning process may be stopped after a certain amount of time. As an example, re-planning of real time modification to a plan which takes longer than five minutes, twenty minutes, one hour, half a shift of a technician, or the like, may be useless as its outcome may be received when it is no longer relevant. As such, a bound on the computation time may be applied and forced to provide for a best available solution during a short time frame. Additionally or alternatively, the sub-problems may be created in a manner which increases the sub-problems iteratively. For example, beginning with the most restricted sub-problem having a smallest number of technicians, tasks, or combination thereof, and adding additional tasks or technicians to broaden the scoped sub-problem. Such process may effectively may guarantee that the least complex sub-problems are addressed first, thereby ensuring that if the computation time frame is used in full, at least one potential plan is available to be used.

After PAA 240 selects a plan, PAA 240 may generate plan update events, such as a technician plan update event and a task plan update event, to be triggered and to update all relevant entities in the system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for real-time update of a Mobile Workforce Scheduling Problem (MWSP), wherein the MWSP comprises: a set of agents and a set of tasks to be performed by the set of agents, wherein a schedule which solves the mobile workforce scheduling problem exists and is being implemented by the set of agents, the method comprising:
monitoring real time information update events provided to a Business Rule Management System (BRMS), the real time information update events relate to real-time implementation of the schedule;
activating, by the BRMS, one or more business rules for schedule change detection, wherein the one or more business rules for schedule change detection are configured to detect a requirement to change the schedule based on the real-time implementation of the schedule;
in response to a detection of a requirement to change the schedule, triggering a re-planning event;
in response to the re-planning event, automatically determining a portion of the MWSP to be re-planned, wherein said automatically determining the portion of the MWSP to be re-planned is based on one or more business rules;
providing the portion of the MWSP to a MWSP solver;
receiving from the MWSP solver, a new schedule for the portion of the MWSP; and
updating the schedule based on the new schedule, whereby a first portion of the schedule is updated and a second portion of the schedule remains unchanged.

2. The method of claim 1 further comprises: notifying an agent of the set of agents of a change in the schedule relating to the agent, wherein the change is a change of a next task for the agent to handle.

3. The method of claim 1, wherein said automatically determining the portion of the MWSP to be re-planned comprises:
applying at least one business rule to identify at least one task whose execution timeframe can be changed;
applying at least one business rule to identify at least on agent whose schedule can be changed.

4. The method of claim 1, wherein the real time information update events comprise an agent location update event of an agent indicating a current location of the agent.

5. The method of claim 4 further comprises:
computing an Estimated Time of Arrival (ETA) of the agent to a location of a task, wherein the task is a next task to be handled by the agent in accordance with the schedule;
in response to determining that ETA is after a planned start time of the task, detecting the requirement to change the schedule, wherein the portion of the MWSP comprises the next task to be handled by the agent and the task.

6. The method of claim 5 further comprises:
performing spatiotemporal analysis to identify agents of the set of agents that can handle the task according to their current location;
filtering the agents according to at least one business rules;
identifying tasks that are potentially affected by a re-planning of the filtered agents; and
adding the identified tasks and the filtered agents to the portion of the MWSP.

7. The method of claim 1 further comprises: receiving a plurality of alternative new schedules from the MWSP solver, scoring each alternative new schedule, and selecting the new schedule from the plurality of alternative new schedules based on the scores.

8. A computerized apparatus for updating a Mobile Workforce Scheduling Problem (MWSP) in real-time, wherein the MWSP comprises: a set of agents and a set of tasks to be performed by the set of agents, wherein a schedule which solves the mobile workforce scheduling problem exists and is being implemented by the set of agents, the apparatus comprising a processor configured to perform the steps of:
monitoring real time information update events provided to a Business Rule Management System (BRMS), the real time information update events relate to real-time implementation of the schedule;
activating, by the BRMS, one or more business rules for schedule change detection, wherein the one or more business rules for schedule change detection are configured to detect a requirement to change the schedule based on the real-time implementation of the schedule;
in response to a detection of a requirement to change the schedule, triggering a re-planning event;
in response to the re-planning event, automatically determining a portion of the MWSP to be re-planned, wherein said automatically determining the portion of the MWSP to be re-planned is based on one or more business rules;
providing the portion of the MWSP to a MWSP solver;
receiving from the MWSP solver, a new schedule for the portion of the MWSP; and
updating the schedule based on the new schedule, whereby a first portion of the schedule is updated and a second portion of the schedule remains unchanged.

9. The apparatus of claim 8, wherein the said apparatus is further configured to issue a notification to an agent of the set of agents of a change in the schedule relating to the agent, wherein the change is a change of a next task for the agent to handle.

10. The apparatus of claim 8, wherein said automatically determining the portion of the MWSP to be re-planned comprises:
applying at least one business rule to identify at least one task whose execution timeframe can be changed;
applying at least one business rule to identify at least on agent whose schedule can be changed.

11. The apparatus of claim 8, wherein the real time information update events comprise an agent location update event of an agent indicating a current location of the agent.

12. The apparatus of claim 11, wherein said processor is further adapted to perform the steps of:
computing an Estimated Time of Arrival (ETA) of the agent to a location of a task, wherein the task is a next task to be handled by the agent in accordance with the schedule;
in response to determining that ETA is after a planned start time of the task, detecting the requirement to change the schedule, wherein the portion of the MWSP comprises the next task to be handled by the agent and the task.

13. The apparatus of claim 12, wherein said processor is further adapted to perform the steps of:
performing spatiotemporal analysis to identify agents of the set of agents that can handle the task according to their current location;
filtering the agents according to at least one business rules;
identifying tasks that are potentially affected by a re-planning of the filtered agents; and
adding the identified tasks and the filtered agents to the portion of the MWSP.

14. The apparatus of claim 8, wherein said processor is further adapted to perform the steps of: receiving a plurality of alternative new schedules from the MWSP solver, scoring each alternative new schedule, and selecting the new schedule from the plurality of alternative new schedules based on the scores.

15. A computer program product or real-time update of a Mobile Workforce Scheduling Problem (MWSP), wherein the MWSP comprises: a set of agents and a set of tasks to be performed by the set of agents, wherein a schedule which solves the mobile workforce scheduling problem exists and is being implemented by the set of agents, wherein said computer program product comprising a computer readable storage medium retaining program instructions, which program instructions when read by a processor, cause the processor to perform a method comprising:
monitoring real time information update events provided to a Business Rule Management System (BRMS), the real time information update events relate to real-time implementation of the schedule;
activating, by the BRMS, one or more business rules for schedule change detection, wherein the one or more business rules for schedule change detection are configured to detect a requirement to change the schedule based on the real-time implementation of the schedule;
in response to a detection of a requirement to change the schedule, triggering a re-planning event;
in response to the re-planning event, automatically determining a portion of the MWSP to be re-planned, wherein said automatically determining the portion of the MWSP to be re-planned is based on one or more business rules;
providing the portion of the MWSP to a MWSP solver;
receiving from the MWSP solver, a new schedule for the portion of the MWSP; and
updating the schedule based on the new schedule, whereby a first portion of the schedule is updated and a second portion of the schedule remains unchanged.
